(19) United States
(12) Patent Application Publication
(10) Pub. No.: US 2007/0137287 A1
(43) Pub. Date: Jun. 21, 2007

(54) Acoustic wave particulate sensor

(75) Inventors: James ZT Liu, Hudson, NH (US); Aziz Rahman, Springfield, IL (US); Michael L. Rhodes, Richfield, MN (US)

Correspondence Address: Intellectual Property;Honeywell International Inc., 101 Columbia Rd., P.O. Box 2245, Morristown, NJ, 07962, US

(73) Assignee: Honeywell International Inc.

(21) Appl. No.: 11/305,923

(22) Filed: Dec. 16, 2005

(51) Int. Cl. G01N 29/00; G01N 37/00

(52) U.S. Cl. 73/61.75

(57) ABSTRACT

An acoustic wave particulate sensor system is disclosed, which includes a piezoelectric substrate; and one or more acoustic wave sensing elements formed upon said piezoelectric substrate. A housing can be provided for maintaining said piezoelectric substrate and the acoustic wave sensing elements, wherein the acoustic wave sensing elements, when exposed to a substance containing particulates, such as, for example, engine oil, responds to a phase change, frequency change, and/or noise level change associated with said particulates in order to identify a noise signature of said particulates and therefore identify differences among said particulates to detect data associated with said particulates.

### TECHNICAL FIELD

Embodiments are generally related to sensor methods and systems. Embodiments are additionally related to particulate sensors. Embodiments also relate to acoustic wave devices, such as, for example, Surface Acoustic Wave (SAW) and Bulk Acoustic Wave (BAW) sensors.

### BACKGROUND

Detecting oil contamination and deterioration, in an internal combustion engine, is important in promoting and prolonging the useful life of the engine and engine oil.

The usable life of motor oil depends on many factors, including the type of oil used, the engine's condition, ambient operating conditions, driving habits, vehicle usage, and vehicle servicing. While most car manufacturers recommend changing the engine oil of an automobile at three months or three thousand miles, whichever comes first, many automobile owners and operators fail to regularly change the engine oil of their automobile within the recommended time frame.

Where deteriorated oil is subject to prolonged use because of infrequent oil changes, the useful life of an automobile engine is greatly reduced. The useful life of an automobile engine may also be reduced by the introduction of contaminants in the engine oil such as: water, antifreeze, or improper types of oil (e.g. four-stroke oil in a two-stroke engine). Accordingly, some types of oil monitoring methods and equipment, for detecting deterioration and contamination of engine lubricating oil, have been created.

Engine oil may contain fine carbon particulates (e.g., 0.03 μm to 0.05 μm) and larger metal particulates (e.g., 3 μm to 5 μm). It is therefore very important to determine the type and the quantity of such particulates. Prior art sensors are adequate for some oil quality detection application. Generally, however, such sensors have difficulty in detecting particulates, particularly because the sensing results are lumped into an overall detection data category and it is difficult to determine types of particulates and the varying particulate sizes. It is believed that a solution to this problem may involve the use of acoustic wave devices.

Acoustic wave devices, such as BAW, STW and SAW, are utilized in a number of industrial, commercial, consumer and military applications. Acoustic wave technology is generally characterized by its reliance on acoustic energy and electrical/acoustic transducers. Acoustic wave components are based on devices in which radio frequency signals are converted to acoustic signals and confined within a small substrate made from, for example, quartz, Lithium Niobate or other piezoelectric crystalline materials. Acoustic waves propagate at relatively low speed with reference to radio waves and, as such, a small substrate may produce relatively long time delays. Acoustic wave devices are useful, however, for example, devices such as resonators and filters utilized in wireless applications and sensors utilized in various environmental detection applications, such as pressure, torque and/or temperature sensors.

Acoustic wave devices, such as a SAW or BAW device, are manufactured from a piezoelectric wafer. Such components are typically manufactured with quartz, which is utilized because the quartz provides for minimal hysteresis, high temperature stability, low creep, low aging and improved long-term stability.

Substances, such as engine oil, thus may contain fine carbon particulates and larger metal particulates. It is very important to determine the type and quantity of such particulates in many applications. Optical sensors (e.g., scattering, etc) can potentially be utilized as particulate sensors, but their application temperatures are often low, their optical windows are difficult to keep clean, and it is also difficult to supply power to such devices in some critical applications. It is believed that a solution to this problem involves the use of acoustic wave devices, as described in greater detail herein.

Liquid properties can be quantified by the speed of shear acoustic waves in a liquid. An ideal liquid cannot support a shear acoustic wave because it does not have shear elasticity or viscosity. Having a shear stiffness μₛ, an elastic solid can support a shear acoustic wave that propagates through the solid much as the better known compressional acoustic wave. The velocity of the wave is (μₛ/ρₛ)^{1/2}, where the variable ρₛ represents the density of the solid. Viscous liquids can support a shear acoustic wave; however the wave decays as it travels and is only able to travel a few wavelengths before being totally dampened out by frictional losses. The complex velocity of these waves can be represented by the equation:(jωη/ρ)^{1/2}= (1+j)(ωη/2ρ)^{1/2}. Measurement of the shear wave velocity thus provides information concerning the ratio of a viscosity of a liquid to its density and thus can be used to measure density if viscosity data is available.

Acoustic waves are related to the flow of liquids in confined geometries, such as capillaries, pipes and the spaces between moving parts in machinery. Such flows are governed by the ratio of the intrinsic viscosity, η, to the density of the material, ρ. The ratio is known as the “kinematic viscosity” and can be represented by the formulation: ηₖ=ηρ

There exist tuning fork type densitometers, which can measure frequency changes as it is filled with the test liquid. Such a method or device, however, is highly susceptible to vibration. One method of reducing susceptibility to vibration involves employing a higher frequency resonator, such that the interference vibrations are well outside the frequency of the sensor.

A tuning fork generally measures the product of density and elastic modulus or the product of density and viscosity and can be implemented in the form of a densitometer. Such a device attributes a resonant frequency shift to density (ignoring elastic modulus) and a shift in Q-value to the viscosity-density product. The method requires prior knowledge of the elastic modulus and careful control of the depth of insertion of the tuning fork into the liquid.

Various densitometer sensor designs have been implemented. For example, some designs employ input and output transducers to measure changes in reflected signal strength of acoustic waves as they reflect near a critical angle of incidence. These viscometers measure either viscosity-density product or elasticity-density product based on the reflection of acoustic waves from the liquid-loaded face of a solid material supporting the transducers. The sensors measure reflection coefficients of the wave from solid-liquid boundaries upon a few reflection events of a pulsed or continuous-wave signal. Such methods offer less sensitivity and resolution of the measured quantity.

### BRIEF SUMMARY

The following summary is provided to facilitate an understanding of some of the innovative features unique to the embodiments and is not intended to be a full description. A full appreciation of the various aspects of the embodiments disclosed can be gained by taking the entire specification, claims, drawings, and abstract as a whole.

It is, therefore, one aspect of the present invention to provide for improved sensor methods and systems.

It is another aspect of the present invention to provide for an improved particulate sensor.

It is a further aspect of the present invention to provide for a particulate sensor based on acoustic wave sensing components.

The aforementioned aspects of the invention and other objectives and advantages can now be achieved as described herein. An acoustic wave particulate sensor system is disclosed, which includes a piezoelectric substrate; and one or more acoustic wave sensing elements formed upon said piezoelectric substrate. A housing can be provided for maintaining said piezoelectric substrate and the acoustic wave sensing elements, wherein the acoustic wave sensing elements, when exposed to a substance containing particulates, such as, for example, engine oil, responds to a frequency associated with said particulates in order to identify a noise signature of said particulates and therefore identify differences among said particulates to detect data associated with said particulates.

In one embodiment, the particulates can be detected using the mass loading effect. In another embodiment, the acoustic wave sensing elements can be configured with a smooth surface and/or a textured surface in order to determine viscosity change and density information associated with the substance.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the principles of the disclosed embodiments.

FIG. 1 illustrates a perspective view of an acoustic wave sensor apparatus that can be implemented in accordance with an embodiment;

FIG. 2 illustrates a block diagram of an acoustic wave sensor system that can be implemented in accordance with a preferred embodiment;

FIG. 3 illustrates a side view of an acoustic wave particulate sensor system that includes the use of sensor illustrated in FIGS. 1-2;

FIG. 4 illustrates a perspective view of a BAW sensor that can be implemented in accordance with an alternative embodiment;

FIG. 5 illustrates a graph depicting a curve unblurred with particulate data, in accordance with one embodiment;

FIG. 6 illustrates a graph depicted a curve blurred with particulate data, in accordance with another embodiment;

FIG. 7 illustrates a graph depicting a high noise level with particulates in accordance with an alternative embodiment;

FIG. 8 illustrates a smooth surface of an acoustic wave sensor in accordance with a preferred, but alternative embodiment; and

FIG. 9 illustrates a textured surface of an acoustic wave sensor in accordance with a preferred, but alternative embodiment.

### DETAILED DESCRIPTION

The particular values and configurations discussed in these non-limiting examples can be varied and are cited merely to illustrate at least one embodiment and are not intended to limit the scope of the invention.

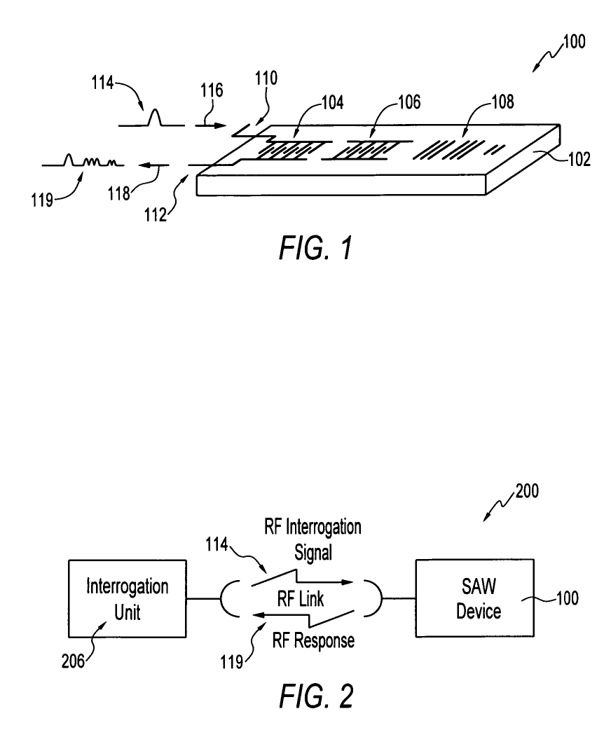

FIG. 1 illustrates a perspective view of an acoustic wave sensor apparatus 100 that can be implemented in accordance with an embodiment. Apparatus 100 includes one or more acoustic wave resonators 104, 106, and 108 formed on a piezoelectric substrate 102. Each resonator 104, 106, and 108 can be configured on substrate 102 as an Interdigital Transducer (IDT) or an IDT electrode. Resonator or IDT 104 can be connected to antenna 110, 112. A Radio Frequency (RF) interrogation signal 114 can be provided to antenna 110 as indicated by arrow 116.

An RF response signal 118 can be transmitted from antenna 112 as indicated by arrow 118. Note that resonator 108 can be configured as a reflector rather than an IDT, depending upon design considerations. Apparatus 100 therefore constitutes a passive wireless acoustic wave sensor device. Apparatus 100 may be implemented as, for example, a SAW, BAW, APM (Acoustic Plate Mode), a flexural plate mode (FPM), a Surface Transverse Wave (STW) , a love wave mode device or element, or other similar acoustic wave sensor device, depending upon design considerations. If apparatus 100 is implemented as an Acoustic Plate Mode (APM) device, for example, rather than as, for example, a SAW or BAW device, substrate 102 can be provided as a quartz plate.

Piezoelectric substrate 102 can be formed from a variety of substrate materials, such as, for example, quartz, lithium niobate (LiNbO₃), lithium tantalite (LiTaO₃), Li₂B₄0₇, GaPO₄, langasite (La₃Ga₅SiO₁₄), ZnO, and/or epitaxially grown nitrides such as Al, Ga or Ln, to name a few. Interdigital transducers 104, 106 and/or 108 can be formed from materials, which are generally divided into three groups. First, IDT 104, 106 and/or 108 can be formed from a metal group material (e.g., Al, Pt, Au, Rh, Ir Cu, Ti, W, Cr, or Ni). Second, IDT 104, 106 and/or 108 can be formed from alloys such as NiCr or CuAI. Third, IDT 104, 106 and/or 108 can be formed from metal-nonmetal compounds (e.g., ceramic electrodes based on TiN, CoSi₂, or WC).

FIG. 2 illustrates a block diagram of an acoustic wave sensor system 200 that can be implemented in accordance with a preferred embodiment. Note that in FIGS. 1-2, identical or similar parts or components are generally indicated by identical reference numerals. As indicated above, component 108 may or may not be provided as an IDT. This depends on the choice of the designer wishing to implement varying embodiments. If component 108 is provided in the context of a reflector configuration upon substrate 102 rather than as an IDT or resonator, then a high frequency electromagnetic wave (e.g., interrogation signal 114) can be emitted the interrogation unit 206 depicted in FIG. 2, and is received by the antenna 110 of the acoustic wave transponder or IDT 104.

The IDT 104 that is connected to the antenna 110 transforms, with the assistance of an inverse piezoelectric effect, the received signal into an acoustic wave, such as, for example, a SAW. The signal (SAW, BAW, etc.) propagates on the crystal substrate 102 towards the reflector or reflector components 108. The reflector(s) 108 can be placed in a particular pattern that reflects part of the incoming wave. What returns to the IDT 104 and/or 106 is a high-frequency series of echoes, which are transduced back into an electromagnetic signal. This is the response signal 119 that is sent through the antenna and back to the interrogation unit 206 depicted in FIG. 2.

The RF response signal 119 carries information about the location and quantity of the reflections together with the information of the propagation and reflection properties of the acoustic wave signal. The interrogation unit 206 evaluates the amplitude, frequency and time of the signal and determines the identification number or calculates the sensor value. Note that interrogation unit 206 can be utilized in the context of system 200 whether or not component 108 is implemented as a reflector or an IDT.

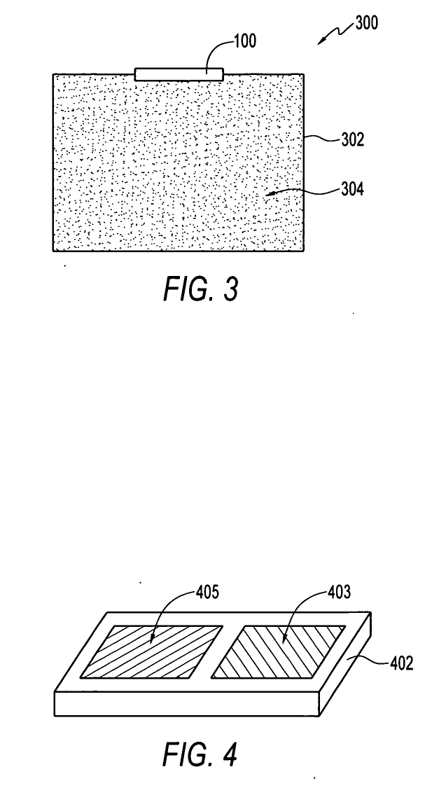

The acoustic wave sensor or sensing device 100 can be implemented in the context of a particulate sensor, such as that depicted in FIG. 3. Note that in FIGS. 1-3, identical or similar parts or elements are generally indicated by identical reference numerals. In general, FIG. 3 illustrates a side view of an acoustic wave particulate sensor system 300 that includes the use of sensor 100 illustrated in FIGS. 1-2. Sensor 100 is exposed to a substance 304 containing particulates encased within a housing 302. The substance 304 can be, for example, oil or any other substance containing particulates for detection and identification by sensor 100. Substance 304 may be, for example, engine oil that contains fine carbon particulates, along with larger metal particulates. In automotive applications, for example, it is very important to determine the type and quantity of such particulates.

In one example, the particulate concentration of the engine oil or substance 304 can be detected by acoustic wave sensor 100 using, for example, the mass loading effect. With a “sorption” type coating, the particulate interactions with the sensor 100 can be a “hit and run” type of interaction, i.e., not a stable frequency variation. The acoustic wave sensor 100 may generate frequency variation data as “noise”. The noise level, however, can be utilized to detect particulate concentration. The noise signature can be utilized to determine the difference among particles. Shock and vibration also introduce noise. Such noise signatures, however, are different from those of particulates. It is preferred that coatings not be used with sensor 100 because such coatings can reduce the resonator Q, introduce instability, and require excessive tie for equilibrium.

FIG. 4 illustrates a perspective view of a BAW sensor 400 that can be implemented in accordance with an alternative embodiment. The BAW sensor 400 functions similar to that of sensor 100, the exception being that sensor 400 is based preferably on Bulk Acoustic Wave (BAW) principles. It can be appreciated, however, that sensor 100 can be implemented, for example, as a Bulk Acoustic Wave (BAW) device. Sensor 400 includes a smooth surface 405 and a textured surface 407. BAW sensor 400 can be implemented in the context of system 300 depicted in FIG. 4 in place of the sensor 100. The smooth surface 405 of BAW sensor 400 can respond to a viscosity change, while the textured-surface 407 of BAW sensor 400 can response to both viscosity and density changes in the substance 304 (e.g., liquid, engine oil, etc).

Instead of a single BAW sensor 400, two BAW sensors may be implemented in a single sensor package, wherein one BAW sensor comprises a smooth surface and the other BAW sensor comprises a textured surface. With two such sensors in the same sensor package, one with a smooth surface and the other with a textured surface, the density information associated with the substance 304 can extracted simultaneously according to the following formulation:

Δf=(ηρ)½

In the equation above, Δf represents the shift of frequency, ηrepresents and ρis the density. From the density measurement, one can obtain its correlation with particulate density. As indicated previously, such devices can be wired or wireless.

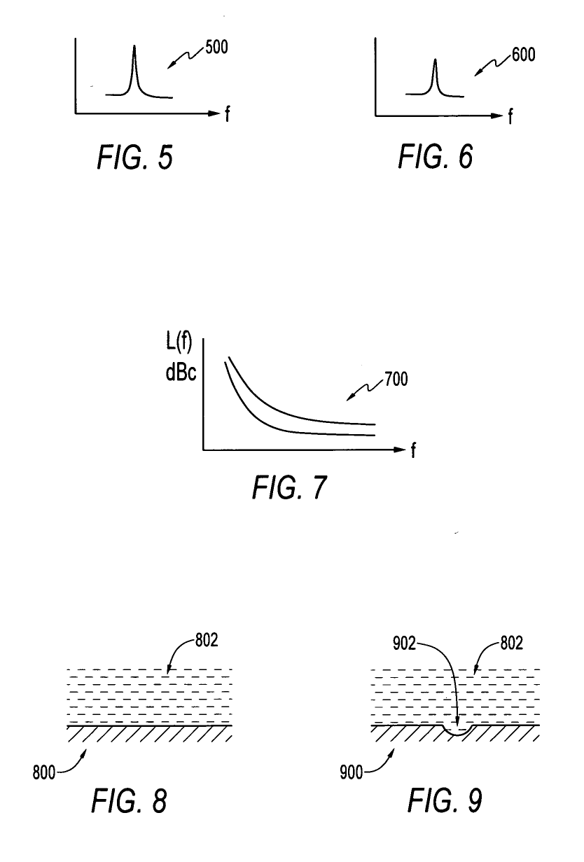

FIG. 5 illustrates a graph 500 depicting a curve unblurred with particulate data, in accordance with one embodiment. FIG. 6 illustrates a graph 600 depicting a curve blurred with particulate data, in accordance with another embodiment. FIG. 7 illustrates a graph 700 depicting a high noise level with particulates in accordance with an alternative embodiment;

FIG. 8 illustrates a smooth surface 800 of an acoustic wave sensor in accordance with a preferred, but alternative embodiment. FIG. 9 illustrates a textured surface 900 of an acoustic wave sensor in accordance with a preferred, but alternative embodiment. Note that in FIGS. 8-9, identical or similar parts or elements are generally indicated by identical reference numerals. Thus, FIGS. 8-9, liquid 802 is depicted. The respective smooth and textured surfaces 800, 900 are generally exposed to liquid 802, which may be, for example, engine oil. Liquid 802 is analogous to substance 304 depicted in FIG. 3. The smooth surface 800 is analogous to the smooth surface 405 depicted in FIG. 4, while the smooth surface 900 is analogous to the smooth surface 407 depicted in FIG. 4.

The textured surface 900 is textured as indicated by the indentation 902 depicted in FIG. 9. In can be appreciated that a plurality of such indentations 902 can form a textured surface. In general, when the piezoelectric resonator vibrates in a shear direction, the liquid mass in the textured area 902 moves with the resonator. Because the volume of the textured area 902 is fixed, from mass loading, one can obtain density information associated with liquid 802. Because density information is related to particulate concentration, particulate information can thus be obtained.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. An acoustic wave particulate sensor system, comprising:
a piezoelectric substrate;
at least one acoustic wave sensing element formed upon said piezoelectric substrate;
a housing for maintaining said piezoelectric substrate and said at least one acoustic wave sensing element, wherein said at least one acoustic wave sensing element, when exposed to a liquid containing particulates, responds to a phase change associated with said particulates in order to identify said particulates and therefore identify differences among said particulates to detect data associated with said particulates.

2. The system of claim 1 wherein said data associated with said particulates comprises a particulate concentration.

3. The system of claim 1 wherein said data associated with said particulates comprises a density of said particulates.

4. The system of claim 1 wherein said data associated with said particulates comprises a viscosity of said particulates.

5. The system of claim 1 wherein said data associated with said particulates comprises data identifying said particulates by particulate type.

6. The system of claim 1 wherein said liquid comprises oil.

7. The system of claim 1 wherein said at least one acoustic wave sensing element comprises a shear-horizontal Surface Acoustic Wave (SH-SAW) element.

8. The system of claim 1 wherein said at least one acoustic wave sensing element comprises a Surface Transverse Wave (STW) element.

9. The system of claim 1 wherein said at least one acoustic wave sensing element comprises a Bulk Acoustic Wave (BAW) element.

10. The system of claim 1 wherein said at least one acoustic wave sensing element comprise at least one of the following:
an Acoustic Plate Mode (APM) element;
a Flexural plate Mode (FPM) element; or
a love wave element.

11. The system of claim 1 wherein said at least one acoustic wave sensing element formed upon said piezoelectric substrate comprises at least two acoustic wave sensing elements, wherein at least one of said at least two acoustic wave sensing elements comprises a textured surface and at least one other of said at least one acoustic wave sensing elements comprises a smooth surface.

12. The system of claim 1 wherein said at least one acoustic wave sensing element comprises a smooth surface and a textured surface formed on said substrate.

13. An acoustic wave particulate sensor system, comprising:
a piezoelectric substrate;
at least one acoustic wave sensing element formed upon said piezoelectric substrate;
a housing for maintaining said piezoelectric substrate and said at least one acoustic wave sensing element, wherein said at least one acoustic wave sensing element, when exposed to a liquid containing particulates, responds to a frequency associated with said particulates in order to identify the mechanical and electrical perturbation of said particulates and therefore identify differences among said particulates to detect data associated with said particulates.

14. The system of claim 12 wherein said data associated with said particulates comprises a density of said liquid.

15. The system of claim 12 wherein said data associated with said particulates comprises a viscosity of said particulates.

16. The system of claim 12 wherein said data associated with said particulates comprises data identifying said particulates by particulate type.

17. The system of claim 12 wherein said at least one acoustic wave sensing element comprises a shear-horizontal Surface Acoustic Wave element.

18. The system of claim 12 wherein said at least one acoustic wave sensing element comprises a Bulk Acoustic Wave (BAW) element.

19. The system of claim 12 wherein said at least one acoustic wave sensing element comprises at least one of the following:
an Acoustic plate mode (APM) element;
a flexural plate mode (FPM) element; or
a love wave element.

20. An acoustic wave particulate sensor system, comprising:
a piezoelectric substrate;
at least one acoustic wave sensing element formed upon said piezoelectric substrate;
a housing for maintaining said piezoelectric substrate and said at least one acoustic wave sensing element, wherein said at least one acoustic wave sensing element, when exposed to a liquid containing particulates, responds to a noise level change associated with said particulates in order to identify said particulates and therefore determine differences among said particulates to detect data associated with said particulates.

21. The system of claim 20 wherein said at least one acoustic wave sensing element comprises at least one of the following:
a shear-horizontal Surface Acoustic Wave element;
a Bulk Acoustic Wave (BAW) element;
an Acoustic Plate Mode (APM) element;
a Flexural Plate Mode (FPM) element; or
a love wave element.
